(19) United States
(12) Patent Application Publication
(10) Pub. No.: US 2002/0146096 A1
(43) Pub. Date: Oct. 10, 2002

(54) Electronic messaging engines

(76) Inventors: Sanjiv (Sam) K. Agarwal, Richardson, TX (US); Neetu Agarwal, Richardson, TX (US); Shivum K. Agarwal, Richardson, TX (US); Neil Kenth Agarwal, Richardson, TX (US)

Correspondence Address: SANJIV (SAM) K. AGARWAL, 1300 CHESTERTON DRIVE, RICHARDSON, TX, 75080, US

(21) Appl. No.: 09/828,195

(22) Filed: Apr. 9, 2001

(51) Int. Cl. H04M 11/00

(52) U.S. Cl. 379/88.13

(57) ABSTRACT

This is a modular, flexible cient method and system for two-way communication, automatic escalation, and remote command execution. The method comprises a set of “engines” which work independently but in parallel—each handling a certain type of message. One or more of these engines can be replicated for scalability, more reliability and efficiency. Further, the whole system can be replicated to give even more reliability and efficiency. The method enables both—interactive and automatic programmatic ways to send messages in various formats including but not limited to text, graphics, voice, text-to-speech, video, etc. from and to practically anywhere in the world. The method also has facilities to convert message of one type to another, instant messaging and scheduled messaging, single destination or broadcast to multiple destinations (also called group messaging), automatic escalation methods, pre-selected or automatic selection of destination.

### TECHNICAL FIELD

This invention relates to methods and systems for automation and delivery of multiple types of messages to single and multiple destinations simultaneously and receive synchronous or asynchronous responses to execute commands on various computer systems.

### BACKGROUND ART

Electronic messaging to various devices such as telephones, facsimiles (fax) machines, pagers, e-mails are well-known arts. Conversion of messaging into different types is also a well-known art as described in U.S. Pat. No. (4,996,707) and (5,091,931). More and more systems and applications are being designed to be able to send out messages to various electronic devices such as those mentioned above. This invention provides several significant improvements to those prior arts. First of all, automation is a big part of this invention that enables enterprises worldwide to have their applications with messaging capabilities—easily and quickly. Additionally, this system allows a two-way communication using many of the messaging devices as remote-controls to enable the recipients of the messages to actually issue commands to selected computer hosts. Furthermore, unlike other prior arts, this system has an automatic built-in escalation process by which the system automatically attempts to deliver messages to a defined hierarchical list of messaging devices or to broadcast messages to all available messaging devices simultaneously (in case the message is a very important message and the recipient must be contacted expeditiously). This invention implements special modular methods (called “engines” in this invention) which allows scalability, efficiency and reliability for practically any enterprise—big or small—almost anywhere in the world. As new messaging devices come along, this system can easily adapt by adding a new messaging “engine” without needing to modify or adversely affecting any existing messaging “engines”. Many other arts require a pre-subscription/pre-registration to be able to receive messages. In this invention, however, it is possible to receive messages without the burden of pre-subscription/pre-registration.

### DESCRIPTION OF THE DRAWINGS

FIG. 1—Flow diagram of the invented system. The two-headed arrows show a complete 2-way communication.

(1) Computer/Application System 1 (including but not limited to web browser based—using direct interface (6) to the database (11))

(2) Computer/Application System 2 (including but not limited to web browser based—using direct interface (6) to the database (11))

(3) Computer/Application System n-m (including but not limited to web browser based—using a standard API (7) via a Data Transport Engine (5))

(4) Computer/Application System n (including but not limited to web browser based—using a standard API (7) via a Data Transport Engine (5))

(5) Data Transport Engine (DTE-1)

(6) Database interface techniques, such as ODBC, JDBC or any other standard database connect methods

(7) Well defined APIs to enable computer/application systems to send and receive data from the database

(8) Database interface techniques, such as ODBC, JDBC or any other standard database connect methods

(9) Enterprises

(10) Enterprise networks

(11) Database

(12) Database interface techniques, such as ODBC or any other standard

(13) Data Transport Engine (DTE-2)

(14) Internet

(15) Cross computer communications protocol such as, but not limited to, Winsock

(16) Data Transport Engine (DTE-2)

(17) Database interface techniques, such as ODBC or any other standard

(18) Database

(19) Messaging engines

(20) Cross computer communications protocol such as, but not limited to, Winsock

(21) Mobile phones

(22) Palm Pilots

(23) Wired phones

(24) Fax machines

(25) E-mail addresses

(26) Pagers

(27) Other messaging devices

(28) Database interface techniques, such as ODBC, JDBC or any other standard database connect methods

(29) Response back

(30) Response back

(31) Response back

(32) Direct interface using a messaging device (and not through an application)

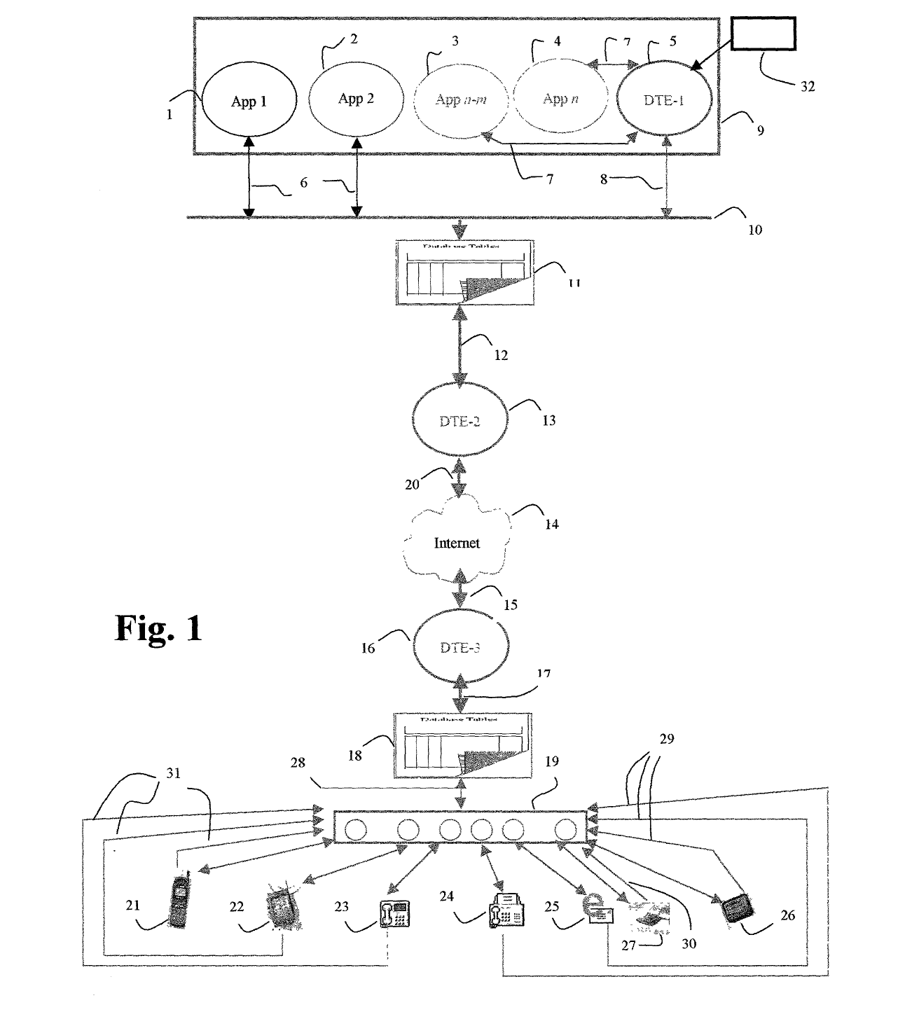

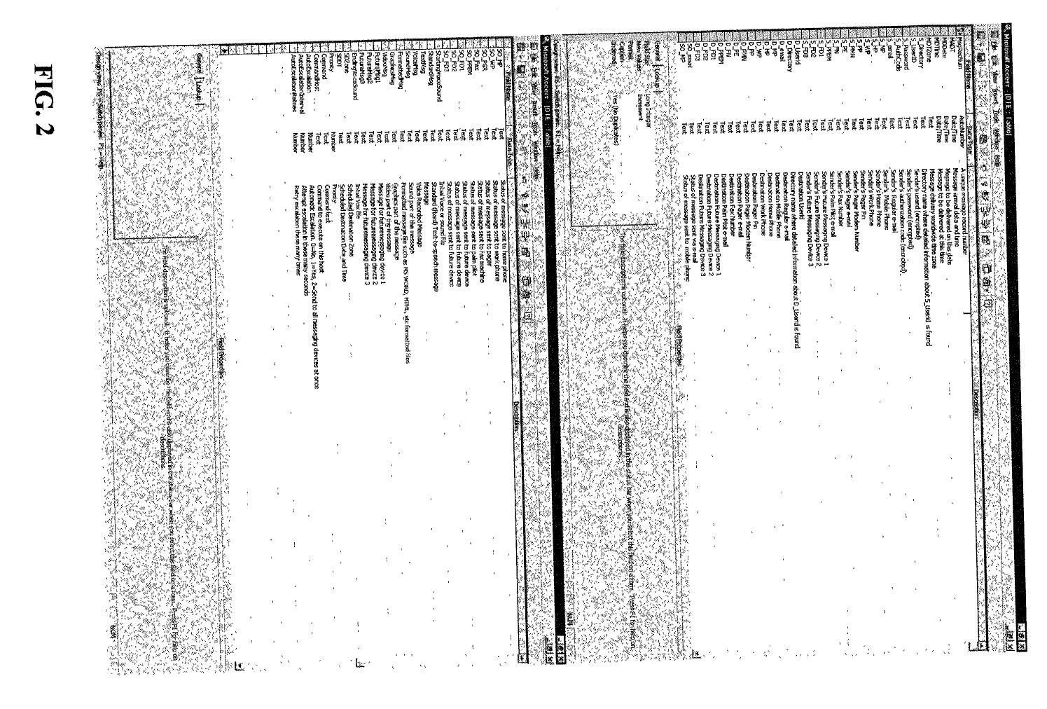

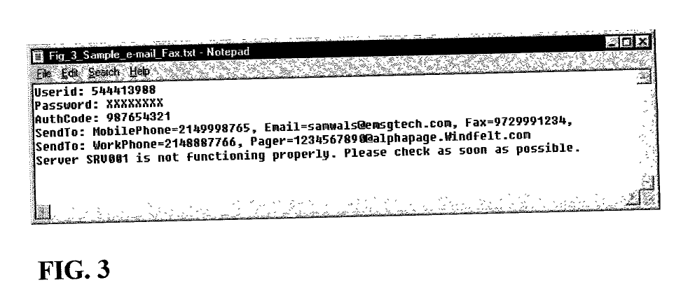

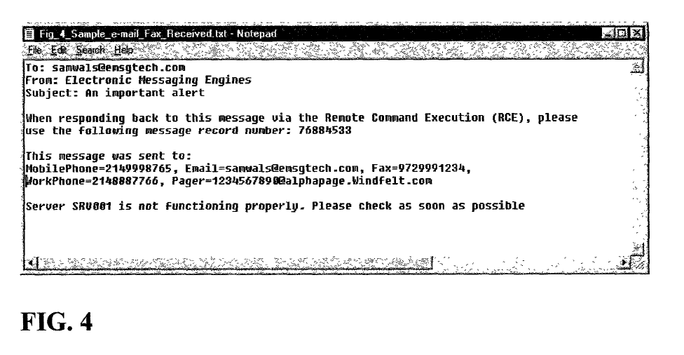

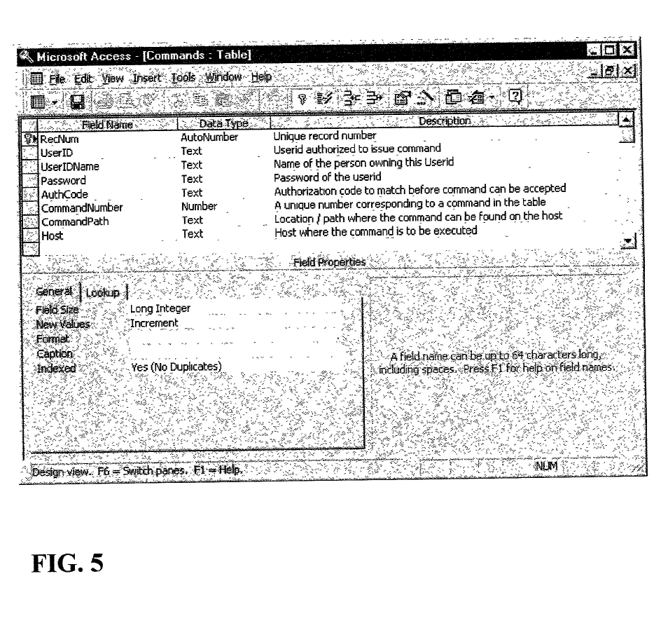

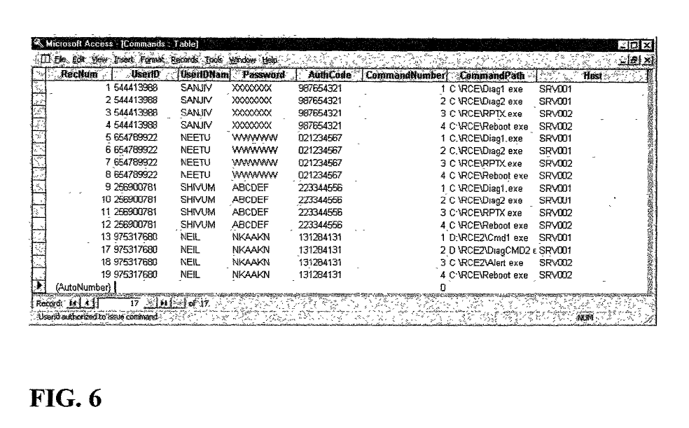

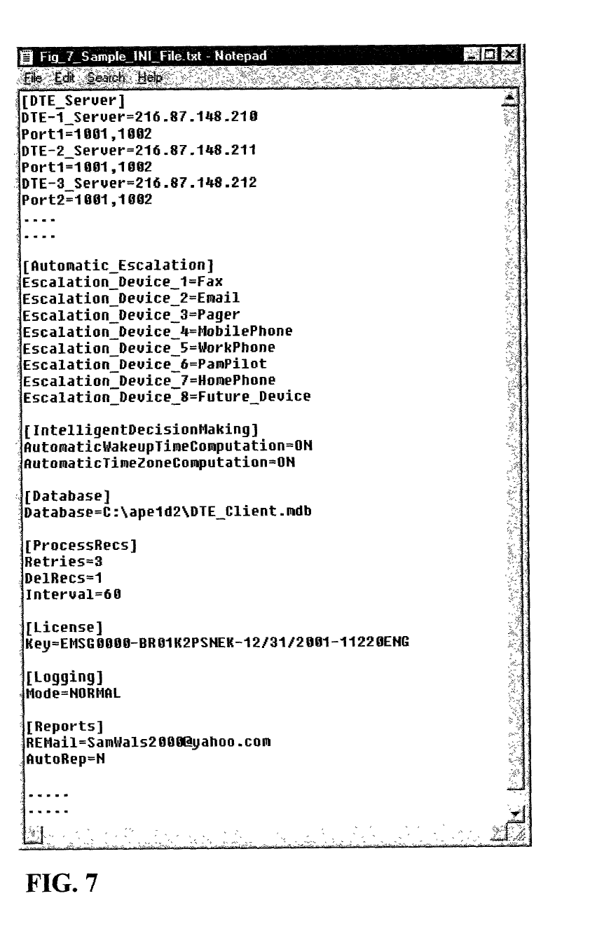

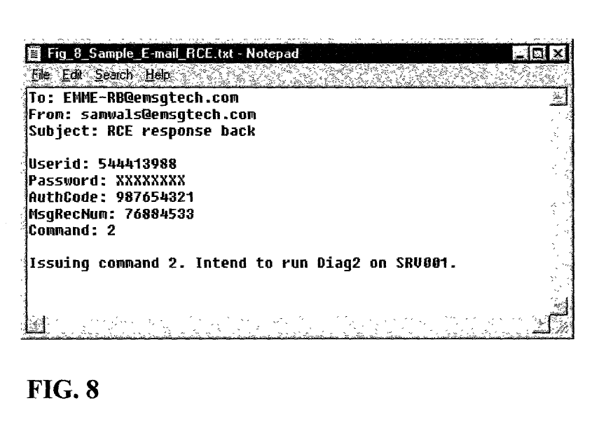

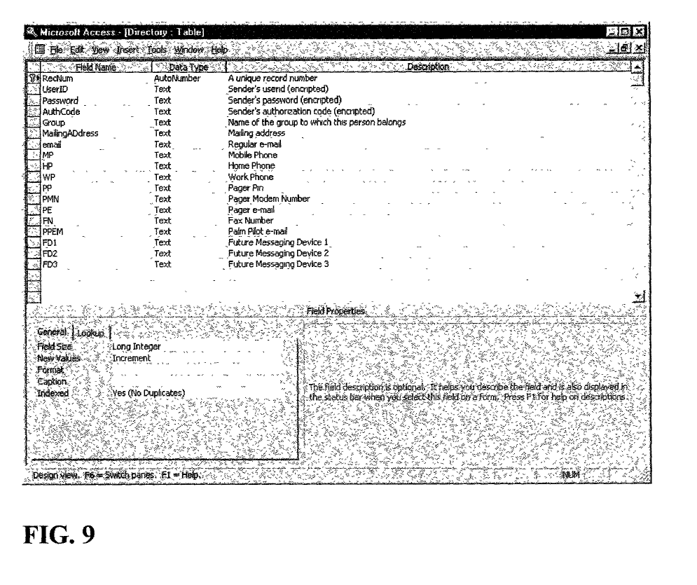

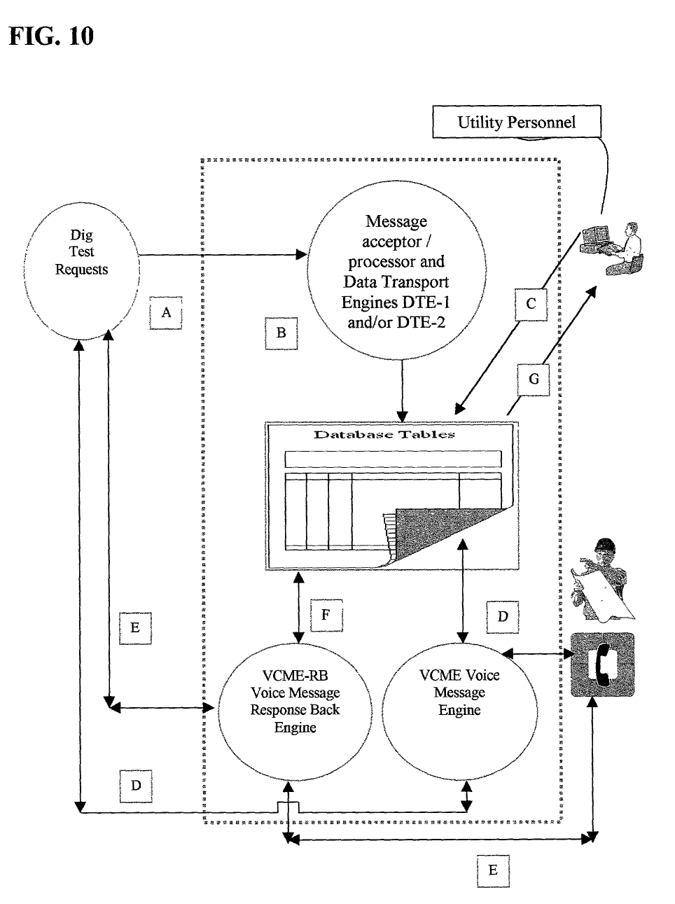

FIG. 2—Database DB-1 (FIG. 1 (11) and DB-2 (FIG. 1 (18) fields description.

Shows various database fields.

FIG. 3—Sample e-mail/fax by which a message can be sent out to multiple destinations.

In this example, a sender sends an e-mail or a fax in a predefined format as shown in the this figure. Each line starts with a special tag such as Userid:, Password: AuthCode: , and SendTo:. Then, there is a blank line. After that, the message to be sent is shown. The Userid:, Password: AuthCode: , and SendTo: tags contain the appropriate information that is parsed to and processed by the system. The sender, in this example, wants to send the message to a Mobile Phone, an e-mail, a Fax, a Work Phone and a Pager. Therefore, the message sender specifies the required information. The system checks the Userid, Password, and the AuthCode and if correct, sends the message out as requested. It automatically converts the text message to speech to be delivered to telephones and also puts it in an e-mail and a fax. For the pager, the system sends an e-mail to 1234567890@alphapage.windfelt.com containing the specified message and lets the service provider handle it. Note that though this example shows email/fax, this idea could be extended to other messaging media as detailed in this document.

FIG. 4—Sample e-mail/fax received by a recipient from the system.

Each of the engines includes a unique identification number such as, MsgRecNum in database DB-1 (FIG. 1 (11)) and Db-2 (FIG. 1 (18). This number is used as part of response back for the system to know which message is a responder responding back to. Similarly, message with same information is received on other messaging devices as detailed in this document

FIG. 5—Commands table description.

The table shows the various fields in the Commands table that is used by the Remote Command Execution (RCE) facility of this invention.

FIG. 6—Sample entries in a Commands table.

This table is used by the system to allow authorized users to be able to execute command through the Remote Command Execution (RCE) facility of this invention.

FIG. 7—Sample INI file used by various engines when initializing.

This file is used by the various engines at initialization time. It serves as start-up parameters. This facilitates flexibility in the engines' behavior.

FIG. 8—Sample e-mail/fax by which a user can execute a command using RCE.

The figure shows a sample method of communication back to the system via email. Note that the user could have used other messaging devices, such as, but not limited to a telephone to send such a response back and request execution of a command. The sample in this figure specifies the MsgRecNum originally received as part of the message and executes Command 2 (see FIG. 7 for the Command Table). Similarly, responses can be sent back and commands can be executed from other messaging devices by supplying the information shown above.

FIG. 9—Sample Directory lookup table.

This table is used by the system to automatically get details regarding a userid (both—recipient and/or sender) and to resolve groups when sending a Group (broadcast) message.

FIG. 10—Flow diagram of a possible “Dig Test” system using this invention.

Description of flow as depicted in FIG. 10.

Step A.

The requests for “dig tests” are received via various messaging devices and methods, including, but not limited to e-mail, fax, wireless telephones, wired telephones, etc.

Step B.

These messages are accepted and processed by messaging engines such as DTE-1 and/or DTE-2 as described in the document. These engines run continuously and processes new request messages as they arrive. They extracts all required information and updates the database.

Step C.

Utility's authorized personnel authorize or deny the request based on various laws and regulations. A GUI interface to the database allows the person to mark the record with approval or disapproval.

Step D.

Another automated messaging engine, such as, but not limited to the Voice Message Engine (VCME), engine which runs continuously scans for such approvals or disapprovals from Step C above. It used advanced telephony technologies to call the appropriate telephone numbers and deliver the approval or disapproval message to the appropriate party. A Utility technician may also be alerted to provide further assistance to the dig requester.

Step E and F.

The technician out in the field, after receiving a message from the system, calls back to acknowledge receipt of the message. The response back engines, such as, but not limited to the Voice Message Response Back (VCME-RB) engine intercepts the calls from technicians. The system prompts the technician for validation, such as a password, authorization code, and/or a matching request number. If the information is correct, the VCME-RB module updates the database indicating that the technician has acknowledged receipt of the message. Similarly, a message is also sent back to the dig requestor and is prompted to acknowledge receipt of the message using the telephone keypad or voice. The database is updated with the current status (step F).

Step G.

Authorized Utility personnel can further view and report on status of various requests or take other actions via a GUI interfaces to the database.

### DETAILED DESCRIPTION OF THE INVENTION

An application (1, 2, 3 or 4) in a worldwide enterprise (9) has a message to send out. If the application already has the capability to separate out the various components of the message (such as, the text, the video, the voice message, etc.), it puts all that information in the database (11) using database techniques such as (but not limited to) ODBC, JDBC, etc. The more powerful feature of this invention is in its capability to provide a standard interface (7) to which all the applications in the worldwide enterprise interface. All that the application has to do is to tell the DTE-1 that it has a message to send, provide required parameters and specify the message and the destinations. DTE-1 also processes messages sent directly by various messaging devices (32). This is accomplished by having code very similar to the “Response Back” engines described later in this document. The difference would be simply that here the system does not look for messages as in a response back format but in an originating message format described in detail in this document.

If the message is in text format, it can be passed to DTE-1 via parameters. If the message is a file and DTE-1 has access to the file, the file name is passed to it. Alternatively, if DTE-1 does not have access to the file, the message data (which could be in different media forms) is passed to it as blocks of parameter-plus-data pairs.

Similarly, if the message is in a graphical format, including fax and/or other graphical formats, the file name is passed to DTE-1 if it has access to the file. Otherwise, the contents of the file are passed to DTE-1 as binary blocks of data. In other words, the simplest and the most powerful feature of this invention is where the applications just pass to DTE-1 the name of the file containing the message and let it break it apart. The various pieces of data are stored in appropriate fields in the database. For example, the text message goes in the “TextMsg” field, the graphical messages go in the “GraphicsMsg” field, the voice message goes in the “VoiceMsg” field, the video message goes in the “VideoMsg” field, etc. If the application is passing a file name to DTE-1, it indicates so by prefixing the information with the word “FILE””. Otherwise, just the binary data is passed to it in blocks of data.

DTE-1 is also capable of receiving and processing messages directly from various messaging devices, such as, but not limited to telephones, e-mails, faxes, etc. In case of receiving telephonic messages, the sender is prompted to specify userid, passwords and authorization codes using keypad or voice. He/she must also specify destination details because the system prompts them by an elaborate menu system. In case of receiving messages by e-mail or fax, the sender specifies the userid, the password and the authorization code in the message which is recognized and verified by the system before the message is accepted or rejected. The received messages should also contain destination details. See FIG. 3 for format of the e-mail or fax to accomplish this. At this point, the DTE-1 engine now treats such messages similarly to those described above, which are being sent by enterprise applications.

Once the data records containing various fields is in the database, the DTE-2 engine (13), which stays in continuous running state, waking up every few moments (determined by a default programmed value or overridden by the system administrator). Additionally, this engine, DTE-2 (13) is also smart enough to make decisions regarding frequency of wakeups based on time-of-day and recent work load activity. This built-in intelligence is called IDM (Intelligent Decision Making). With this technique, the DTE-2 (13) engine wakes up more frequently if it determines, based on past few minutes of work activity and by comparing historical work data, if it is a busy time of day. This feature turned on or off by various INI parameter [IntelligentDecisionMaking] set by the system administrator.

DTE-2's main role is to transport data from database DB-1 over to DTE-3 (16). The Intelligent Decision Making (IDM) code in DTE-2 also determines if certain records do not need to be transmitted at this point. These decisions are made for those records that have a future date and time for delivery specified. The IDM code also uses the various international time zones to determine if it is time to transmit the data or not. For example, if the message is to be transmitted to a destination in Japan on Mar. 21, 2000 at 11:15AM Japanese time, the IDM code in DTE-2 is able to correctly compute and determine if the time has arrived to send the message or not even though the DTE-2 code may be running on a computer in the USA. This part of the IDM code is ON by default if there is no setting specified in the INI file. If the setting is OFF, the system automatically converts over to “instant messaging” system because the messages are then sent out right away. Thus, this system is for international use regardless of where the computer servers may be installed.

Another powerful feature of this system is that it allows simultaneous (broadcast) messages to a group of recipients. To do this, the sender must first setup “groups” in a database (11) and allow access of it to DTE-2. When transmitting the data to DTE-3, DTE-2 also sends the group information with it. When DTE-3 receives such group requests, it too uses IDM (Intelligent Decision Making) code to group the recipients together. This part of the IDM code is always ON regardless of the INI settings. For example, for an e-mail mode of messaging, all the recipients are specified in the addressee list and just one e-mail suffices. For sending out alphanumeric text messages to pagers, messages are grouped by the paging service provider reducing the number of TAP (Telocator Alphanumeric Protocol) calls and thus significantly speeding up the delivery process. In other cases, however, such as in case of sending voice messages over the telephone, the system has to call each telephone number. In that case, efficiency is achieved by the voice messaging engine (19) by spawning multiple sub-tasks with each handling a phone call each over multiple phone lines or a broadband multiplexed phone line. Various models of computer telephony cards are available from various vendors on the market to accomplish this. Similarly, a capable computer telephony development language can be used to accomplish this.

The main purpose of Data Transport Engine DTE-3 (16) is to receive data from the Data Transport Engine DTE-2 (13) over the Internet using a communication protocol such as but not limited to TCP/IP and using Winsock (20, 15) for transferring data from anywhere to anywhere in the world. This idea of this system is at the heart of making this system a powerful worldwide solution. DTE-3 receives the data and separates it out into appropriate fields in the database DB-2 (13).

The various messaging engines (19) are in constant running state. Just like the DTE-2 (13) Data Transport Engine, they too wake up periodically to check for work to do. The frequency of the wakeup is either a default value, customizable via INI parameters set by the system administrator or by using IDM (Intelligent Decision Making) code. The IDM makes decision about wakeup time based on recent work activity and historical data. Whether the engines should use IDM for computing wakeup time is controllable by INI parameters set by the system administrator. By default, the setting is ON. If the setting is ON, the engines wakeup most frequently of the default, the wakeup time specified in the INI or the computer wakeup time—whichever is most frequent.

Each of the engines is responsible for specific type of destination messaging device. That is, for example, the Voice Message Engine (VCME) (19) is responsible for sending out voice messages to wired and wireless telephone; the pager message engine (PGME) (19) is responsible for sending out messages to pagers; the e-mail message engine (EMME) (19) sends out e-mails; the fax message engine (FXME) (19) is responsible for sending out faxes, the Palmpilot Messaging Engines (PPME) (19) sends messages to palmpilots, and the Futura Messaging Engine (XXME) (19) is the messaging engine that handles any new messaging devices.

NOTE: As part of out-going messages, each of the engines includes a unique identification number such as, MsgRecNum in database DB-1 (11) and Db-2 (18). This number is used as part of response back for the system to know which message is a responder responding back to.

The Voice Message Engine (VCME) (19) works as follows: It stays in continuous running state and wakes up at certain intervals as described above. It queries the database to see if there are any voice-messages to send. If so, it spawns the required number of subtasks. The number of subtasks that are spawned depends on telephony ports available at that given time. The VCME communicates continually with the subtasks keeping track of progress and final status of each subtask. If a subtask succeeds in delivering the message, it posts a “success” message back to the engine, which in turn updates that appropriate record in the database. If a certain subtask fails to deliver the voice message, it re-tries a specified number of times keeping the VCME informed of the cause of failure in each of the tries. Failure causes such as but not limited to ‘busy’, ‘no-dialtone’, etc. are all communicated back to the VCME. Also note that the subtasks are capable of delivering both a recorded voice message and text-to-speech converted messages. By default, each message is given up to 3 tries (or as specified in the INI file) towards a successful delivery. Despite the retries, if the messages fail to get delivered, the failed messages are moved to “failure” table in the database DB-2 (18) from where they are processed again, later. If the messages fail to get delivered again, they are placed in the “double failure” table in the database DB-2 (18) and the VCME does not attempt to process them again. All throughout the various process, the database DB-2 (18) fields are updated to keep track of attempts, intermediate and final results of the delivery process.

As each subtask finishes, the VCME spawns additional subtasks until all the messages in this batch are finished. The VCME then goes to sleep to wakeup after a certain interval as explained above. If the VCME has no new messages to deliver, it starts processing the messages that may have failed in a previous attempt. These messages, as explained above, are found in the “failure” table of the database DB-2 (18).

The Pager Message Engine (PGME) works as follows: The pager engine has two modes of operation. In the first mode, it uses a paging protocol such as but not limited to TAP (Telocator Alphanumeric Protocol) protocol—which is a well-known art. TAP protocol requires a dialup number, which is different for each pager service provider, and a pager pin number. The dialup number allows a computer to connect to a pager service provider's computer and transfer the message to be sent to the pager service provider's computer. The advantage of this invention is that it can work with any and all pager service providers because the various dialup numbers are kept in a database, which serves as a directory lookup (DLD) (11). As such, if the pager service provider changes, or changes the dialup number and the users acquire new pagers, the engine continues to work with no changes in the code. Only the database needs to be updated to reflect the new dialup number and/or the new pager numbers. In this mode, it spawns subtasks very similar to the process described in the VCME, above. For group paging requests, however, the engine is able to send messages to several pagers by a single dialing. Pager protocols such as TAP provide status codes throughout the dialing and sending of message process. The spawned processes keep communicating these status codes back to the PGME, which in turn updates the various database fields. Just like VCME engine, up to 3 attempts (by default, or as specified in the INI file) are made to send out a pager message. If the attempts fail, the message is put in the “failure” table for a later retry. If the retry attempts also fail, the message is put in the “double failure” table and the PGME does not attempt to send that message anymore. Another enhancement found in this engine is its backup method of sending out pager messages. Many pager service providers accept e-mail in a certain format addressed in a predefined manner. See FIG. 3 for a sample of such an e-mail. For example, a service provider called Windfelt (an imaginary name) may be servicing a pager number 1234567890 and accepts an e-mail addressed to 1234567890@(alphapage.windfelt.com. The Subject: line and the body of the text contains the text message that needs to be sent to the pagers. If the message is a long message, the Subject” line contains only part of the message (first 100 characters, for example). Furthermore, a group can be set up by the pager service provider who can then assign several pagers to the group. Let's say the group is called 9876543210 and the pager service assigns 200 pagers to that group. Then, if an e-mail is addresses to 9876543210@alphapage.windfelt.com, the message will go out to all 200 pagers simultaneously. Note that this method of grouping which is provided by the pager service provider also works with the TAP protocol explained above. Note also that some other pager service provider may have a different format of their e-mail address. The beauty of this invention is that the pager engine does not need to know that because the information is provided to it by the requesting applications (1, 2 3 or 4) in the database DB-1 (11) and DB-2 (18) and transmitted by DTE-2 (13) and DTE-3 (16). Therefore, the engine continues to work for many existing and new pager service providers without any changes.

The E-mail Message Engine (EMME) works as follows: It uses methods defined in protocols such as but not limited to SMTP (Simple Mail Transfer Protocol), MAPI (Mail Application Programming Interface), etc. to send out e-mails either in plain text or formatted (such as but not limited to HTML) format. As a backup method, it can also use any other acceptable e-mail protocol to accomplish the task. Format of a typical e-mail is shown in FIG. 4. Similar to the VCME and PGME, the EMME also wakes up at certain intervals and processes e-mail requests that it finds in the database DB-2 (18). The difference, however, is that it does not do retries because that is a function provided by the operating system services. Note that it also updates the database with status upon completion of each e-mail send process. The e-mail engine is also capable of sending attachments including but not limited to text, voice, sound, video and graphical data.

The Fax Message Engine (FXME) works as follows: The FXME stays in constant running status and periodically wakes up to process any fax messages that may be waiting in the database. The frequency of wakeup, as in other engines, depends on a default value, an INI parameter or the IDM (Intelligent Decision Maker) code that computes the wakeup interval based on recent activity and historical data. Whether to use the IDM code for computing the wakeup time is easily controllable by the system administrator via an INI parameter. It uses any fax modem or fax hardware to send the faxes out. Similar to other engines described above, it too is capable to driving multiple fax ports simultaneously and spawns subtasks to achieve sending out of several concurrent fax messages. The fax messages include both text and graphics. The spawned subtasks give up to 3 tries to send out each fax message and keep the FXME engine informed of the status of the whole process throughout. In turn, the FXME keeps the database updated with the status messages as they are received from the spawned subtasks. If the fax message fails to go through after 3 attempts, the message is moved to the “failure table” in the database DB-2 (18). Later, as in other engines, the fax engine wakes up and if it has no new messages to send, it starts processing the messages in the “failure” table. If the message goes through this time, appropriate status is reflected in the database and the engine continues to execute other tasks such as process the next message. If the message fails to go through again, the message is moved to a “double failure” table in the database DB-2, the status is updated in the database and the engine continues to execute other tasks such as process the next message.

The PalmPilot Message Engine (PPME) engine works as follows: Palmpilots (also known as PDAs) are hand held electronic computer devices. With the recent advancements in technologies, the new models are now capable of connecting to the Internet via a built-in wireless. Users of such models may choose to get a separate e-mail address assigned that enables the palm pilot to view their e-mails directly from the Internet. Other models, which are not directly Internet enabled, can still download their e-mails by connecting them to a PC, for example.

The PPME engine is very similar to the E-mail Message Engine (EMME) and communicates to the Palmpilots by sending e-mails. The methods pertaining to wakeup, retries, moving failed messages to “failure” table and “double failure” table, etc. are the same. The significant difference is that this engine sends messages to Internet enabled palmpilots that have a different e-mail address. It extracts its information regarding the recipients' e-mail address from a separate field in the database. Further, since it handles its own share of e-mails, without burdening the EMME engine, the overall system efficiency and reliability is improved because these engines work together in parallel.

The Future Message Engine (XXME) works as follows: This engine handles any new messaging device that may come along in the future. The engine contains appropriate code to send and process messages from any such devices. Again, just like the other engines, it too contains coded logic methods for wakeup, retries, moving failed messages to “failure” table and “double failure” table, etc. The modular design of this system allows addition of such engines very easily and quickly without adversely affecting other engines. This is a very important and powerful feature of this invention.

THE RESPONSE BACK ENGINES:: The Response Back Engines, such as, but not limited to VCME-RB, EMME-RB, FXMERB, XXME-RB, etc. are designed to process responses from recipients of messages. When a recipient gets a message, he/she can choose to execute a command on a given computer host by using a messaging device as a remote control. If the person uses a telephone as a Remote Command Execution (RCE) device, then VCME-RB processes the commands given by the user either by the telephone keypad or via voice commands. After verification of userid, password and authorization code, the command is accepted (as described in this document). Similarly, the EMME-RB accepts commands via e-mail and FXME-RB accepts requests for command execution via fax. In each case, the userid, password and authorization codes are verified before accepting the commands. The XXME-RB executes similar function for any future messaging device capable of sending a message back.

Let us now look at this in more detail. This invention provides a lot of flexibility and ease of use. First of all, a database DTE-1 (5) is set up with appropriate tables and fields which will contain the information that enables this system. The database contains a table for containing the messages arriving in various formats including, but not limited to text, graphics, voice, sound, video, etc. The table contains a minimum of fields shown in FIG. 2.

This database resides on a server in an enterprise. Once the database is set up, an application in an enterprise can use known techniques such as but not limited to ODBC (Open DataBase Connection), or JDBC (Java DataBase Connection), etc. to put required information in the database DB-1 (11). As a flexible alternative, a better solution for enterprise wide application may be to use a standard interface such as DTE-1 (5) to put and extract data records from the database as shown in FIG. 1. Using DTE-1 provides enterprise wide standardization and ease of use and future modifications. This provides a considerable amount of flexibility and let's each enterprise choose their own way of putting or retrieving the data from the database. They can interface directly to the database, use a standard vendor provided database interface engine, such as, DTE-1 (5) or design their own database interface engine similar to DTE-1 (5).

When using the Data Transfer Engine DTE-1, all that the applications have to do is to specify the appropriate fields and their values as parameters in the interface.

An example: An enterprise application wants to send out a message containing text, formatted text and graphics as voice message to a mobile phone, a fax and an e-mail to a Palmpilot. The application can choose to put all these pieces of information in the database or simply choose a standard interface DTE-1 and pass it all these parameters as shown below.

Message=The system called The Electronic Messaging Engines is a great invention.

Sender's userid=SKA

Sender's password=ABCD

Sender's Authorization Code=EMSG0000-BR01K2PSNEK-12/31/2001-11220

Sender's e-mail=SamWals@emsgtech.com

Sender's Work Phone=(214) 999-1234

Formatted Message file location=\\fs002\MsgSys\SamWals\\Msg123.doc

Graphics Message file location=\\fs002\MsgSys\SamWals\Gpx123.jpg

Destination Mobile Phone=(214) 888-0987

Destination Fax=(972) 987-2468

Destination PalmPilot e-mail=emsgtech@palmnet.net

A DTE-1 interface invocation from the enterprise application may look like this:

DTE-1 S_Userid=”SKA”, S_Password=”ABCD”, S_AuthCode=”EMSG0000-BR01K2PSNEK-12/31/2001-11220”, S_email=”SamWals@emsgtech.com”, S_WP=”(214) 999-1234”, TextMsg=” The system called The Electronic Messaging Engines is a great invention.”, FormattedMsg=”\\fs002\MsgSys\SamWals\Msg123.doc”, GraphicsMsg=”\\fs002\MsgSys\SamWals\Gpx123.doc”, D_FN=”(972) 987-2468”, D_MP=”(214) 888-0987”, D_PPEM=”emsgtech@palmnet.net”

The DTE-1, when invoked with the parameters and information as shown above will put appropriate pieces of information in the desired fields in the database. Additionally, it will access and read the “FornattedMsg” file and the “GraphicsMsg” file in binary form and put the data in the database field also. Thus, the enterprise wide applications do not have to worry about coding logic to determine the various formats of files, the process of reading those various files and then to put the file data in the database. Thus, this is a very simple but powerful method.

An even more flexible and powerful method can also be adopted by the enterprise applications. In this case, the applications do not even need to know information such as the destination fax number, the destination mobile phone number, etc. etc. All they need to do is specify information regarding the S_Directory, the D_Userid and D_Directory (see FIG. 9). The interface to DTE-1 format of the ongoing example then will look like this:

DTE-1 S_Userid=”SKA”. S_Password=”ABCD”, S_AuthCode=”EMSG0000BR01K2PSNEK-12/31/2001-11220”, S_Directory=”S_Dir1”, S_email=”Yes”, S_WP=”Yes”, TextMsg=” The system called The Electronic Messaging Engines is a great invention.”, FormattedMsg=”\\fs002\\MsgSys\SamWals@Msg123.doc”, GraphicsMsg=”\\fs002\MsgSys\SamWals\Gpx 123.doc”, D_Userid=”WXYZ”, D_Directory=”D_Dir3”, D_FN=”Yes”, D_MP=”Yes”, D_PPEM=”Yes”

In this case, the DTE-1 in the S Dir directory table and automatically get the data for S_email and the S_WP fields pertaining to userid “ABCD” and substitute those real values for “Yes”. Similarly, it will also look up in the directory table “D_Dir3” for information pertaining to userid “WXYZ” and substitute values for D_FN, D_MP and D_PPEM automatically. Then, the DTE-1 engine will put a record in the database DB-1 with all the desired fields values determined correctly. The fields that are not specified are left blank or just contain one asterisk (*). If the message is being sent out to a group consisting of several users, the system resolves and expands that group into multiple entries into the DB-1 database.

The S_Directory is used to verify the userid, the password and the authorization code information for security purposes and to ensure that only valid and authorized users can access the system. If the S_Directory is not specified in the interface command, the system uses a default directory for verification. If the userid, password and the authorization codes do not match or are not found, the message is rejected and is logged in a “Rejected” table in the database DB-1.

Now the data records are in the database DB-1 (11), the Data Transport Engine DTE-2 (13) and DTE-3 (16) come into play. The DTE-2 and DTE-3 are in continuous running state and wakes up periodically (as explained in this document) and transmits and receive the data records, respectively. In other words, the DTE-2 (13) sends the records and DTE-3 receives them and puts them in database DB-2 (18). The reason for doing this is that the various messaging engines may be running on another server or servers. This technique allows enterprises not to have to acquire their own hardware or the messaging engines but can utilize the hardware and these messaging engines provided by a service provider. However, if an enterprise wants to have their own hardware and the messaging engines, this system allows them to have that also. How does DTE-2 know where to send the data? This is easily accomplished by specifying one or more server address where the Data Transport Engine DTE-3 may be running. This specification is done via INI file parameters that DTE-2 engines use when execution initiates. (See FIG. 7 for a sample INI file). This gives the enterprises maximum flexibility, efficiency and reliability because they can use multiple servers in any combination for the purpose of transferring messaging data.

The DTE-2 and the DTE-3 engines communicate over the worldwide web using a standard communication protocol such as but not limited to TCP/IP (Transmission Control Protocol/Internet Protocol) Winsock (Windows Sockets). Each record is identified by a unique record number (“RecNum”) field and the “Status” field keeps the updated status information. For example, upon successful transmission of data from DB1 by DTE-2 to DB-2 via DTE-3, the “Status” field is updated as “EMSG0001—-Record transmitted successfully”. Each status message has a status message code such as EMSG0001 (to EMSG9999) as shown in the above example.

Once the data records are written out to the database DB-2 (18), they are picked up by various messaging engines that are continuously running as described in this document. Each engine scans the database for new records and determines if there are message for it to process that have the destination device that the particular engine is responsible for.

For example, the Fax Message Engine (FXME) processes all those messages that have a number specified for the D_FN field (Destination Fax Number). Similarly, the Voice Message Engine (VCME) picks up all those messages that have telephone numbers specified in any or all the D_MP, D_HP, or the D_WP fields. If the message has several destination fields specified, then multiple message engines process the message simultaneously each sending the message to the indicated device. Thus, significant efficiency and reliability in the delivery of the message is accomplished.

This in the example given earlier (above), where D_MP (destination mobile phone), D_FN (destination fax number) and D_PPEM (destination palmpilot e-mail) was specified, the three engines—the Voice Message Engine (VCME), the Fax Message Engine (FXME) and the PalmPilot Message Engine (PPME) will process the message delivering it to appropriate destinations and updating the appropriate status fields, such as the “SO_MP” field. The VCME will automatically convert the text message (contained in the “TextMsg” field of the database) to speech and deliver it in combination with any prerecorded voice and sound message files that were sent via the various database fields, such as, “StartingVoiceSound”, StandardMsg, “VoiceMsg, “SoundMsg”, and “EndingVoiceSound”. The VCME will dial the mobile phone specified and when the phone is answered either by a human or an answering machine, it will play the prerecorded sound and voice messages and also play the converted text-to-speech message. This combination and feature of this engine where a mixture of prerecorded sound and voice messages and text-to-speech messages gives the enterprise applications a lot of flexibility in sending any and all kinds of messages to various telephones.

Simultaneously, depending on the workload that the fax engine may be handling at that given point in time, the FXME engine will also process the message because the sender had requested that the message be sent out to a fax destination also. The fax engine sends out the TextMsg and also combines it with the GraphicsMsg information that the sender had specified. It too updates the fax status “SO_FN” field in the database to indicate success, retries or failure.

Again, simultaneously, depending on the workload that the PalmPilot Message Engine may be handling at that given point in time, the PPME engine will also process the message because the sender had requested that the message be sent out to a palmpilot destination also. The palmpilot engine sends out the TextMsg and also combines it with the GraphicsMsg information that the sender had specified. It too updates the palmpilot status “SO_PPEM” field in the database to indicate success, retries or failure.

In the ongoing example, had the sender chosen other messaging devices as destinations also, the other messaging engines—the Email Message Engine, (EMME) (19), the Pager Message Engine (PGME) (19), the future device message engine (XXME), would all have stated processing the message also—each taking care of delivering the message in an appropriate format to the appropriate messaging device. Therefore, potentially, and as a powerfill feature of this invention, a message can be easily sent out to any and all messaging devices, simultaneously and not just one pre-selected device.

### AUTOMATICALLY INFORMING THE SENDER

As part of updating the various status fields, each engine also checks to see if the sender had requested that an update message be sent back. In other words, the sender has the capability to request the system that he/she be informed if the message got delivered or not. The beauty of this invention is that the sender can choose to be notified on any of the appropriate messaging device, too. In the example taken above, the sender had chosen to be notified of status on his/her email and work phone (because the “S_email” and the “S_WP” fields were specified in the request). The various engines look at these fields to see if the sender has requested such a notification and if so, they automatically send the status message back to the sender on the messaging device of his/her choice. In this example, the Voice Message Engine (VCME) (19) will send the status message via voice alert to the specified work phone and the E-mail Message Engine (EMME) will send an e-mail back to the sender. If the sender specifies no such fields, then they are not bothered by unwanted status messages from the system.

### AUTOMATICALLY UPDATING THE STATUS FOR BENEFIT OF APPLICATIONS.

Another powerful feature of this invention is described below. Once the various engines finish processing a given message, as described above, they update the various status fields with information. Now, the process of transmitting the data back from the database DB-2 (18) starts. The Data Transport Engine (DTE-3) (16) send the original “RecNum” (which is a unique value for each record), and the associated status field information back to the database DB-1 by communicating back to DTE-2 over the worldwide web using the TCP/IP Winsock or any other valid communications protocol. DTE-2 receives the status information, finds the appropriate record in the database and updates the fields with the information it has received.

Now that the updated information is available in the database, the enterprise applications again have the flexibility to query the status directly or utilize a standard DTE-1 type of interface to query the status of the sent messages. After the status is obtained, an enterprise application can make further decisions. Thus total flexibility is given to the application developers.

Thus, a complete two-way communication system is achieved between any worldwide enterprise applications and any of the available messaging devices. Moreover, the two-way capability of this invention becomes even more pronounced because it provides the Remote Command Execution (RCE) capability (See details regarding RCE in this document). RCE allows authorized persons to be able to execute commands on certain hosts using their messaging devices as remote controls.

Remote Command Execution (RCE)—How to execute commands using your messaging device as a remote control:

To set up this capability, each enterprise sets up a “commands” table (shown in FIG. 5 and FIG. 6) containing fields such as Userid, UserIDName, Password, Autheode, CommandNumber, CommandPath and Host on which the command is to be executed.

Description of fields in the “Commands Table”

The commands table carries the same name as the host name for which it is being customized. That gives an enterprise more control by having more than one commands table and assigning different administrators and authorizations. Additional fields are described below:

Userid—Userid of the person authorized to execute commands described in this table.

UseridName—Name of the person to whom the userid belongs.

Password—Password for the Userid. It is checked and verified before a command is executed to ensure only authorized userids are executing commands via the RCE capability of the invention.

AuthCode—Authorization code which gives another layer of security. CommandNumber—A unique integer number that corresponds to a particular command. This number is used by the person when wanting to execute a command via RCE to indicate which command he/she wants to execute.

CommandPath—A full path of the command that will be executed on the host specified in “Host”.

Host—This is the name or address of the host computer on which the requested command is to be executed. The system should be set up by the system administrator to be allowed to execute the commands on behalf of the requesting user on the specified host.

The RCE capability in this invention allows authorized persons to execute commands on certain hosts using their messaging device as remote controls. Consider the following scenario: A person (Server Administrator) gets an alert message sent to him/her via a telephone voice message indicating that a certain computer host may be malfunctioning. This message may be generated by his enterprise monitoring system that monitors various servers in his enterprise. After delivering the message, the VCME engine transfer control to the VCME-RB engine which starts prompting the person to allow him to execute a command if he/she wishes to do so at this point. The system prompts the person to enter the userid, the password and the authorization code to ensure security and prevent unauthorized access to this capability of the invention. The person provides these by using his keypad or by speaking into the phone. The VCME-RB engine verifies the correctness of the userid, the password and the authorization code from the database DB-2. If correct, the VCME-RB prompts to specify the command he/she want to execute. These commands must be pre-defined in a “commands” table in the DB-1 database. Note that the userid, the password, the authorization code pertaining to this particular userid are transmitted from DB-1 to DB-2 with the message and can now be used for checking authorization. The chosen command and the chosen host information is then transmitted back to DB-1 by DTE-3 which communicates to DTE-2 as described before.

Once the data is communicated back to DB-1, another engine called Remote Command Execution Engine (RCEE) verifies the userid, the password, the authorization code. It also verifies that the command requested is a valid one and if found in the table and launches the command on the specified host. So, in the ongoing example of a server administrator receiving an alert message indicating a certain host may be malfunctioning, he/she can choose to execute some commands right there using his telephone keypad as a remote control. He/she may choose to execute a diagnostics program or reboot the machine, etc. Of course, as explained above, those commands should already be defined in the Commands table.

Also note that this capability of executing commands remotely via the RCE is also available through other messaging means such as e-mail and faxes. Further, the person can also use the telephone to call back later and interface with the VCME-RB and give commands. In each case, as before, the userid, the password and the authorization codes are verified to ensure security and authorized use.

If an authorized user wants to use e-mail for RCE:

The authorized person creates an e-mail in a pre-defined format (see FIG. 8). In this e-mail, he/she includes the userid, password, authorization code, the host name and the command number to execute. This e-mail is sent to a special mailbox called, say for example, EMME-RB@myenterprise.com. The EMME-RB engine processes these e-mails and updates the records in DB-2 which are then transmitted back to DB-1 as described above. The RCEE then launches the command as described above.

If an authorized user wants to use fax for RCE: Very similar to using the e-mail process for RCE, the user creates a fax and send it to a specified fax number including the userid, the password, the authorization code, the host name and the command number in a certain predetermined sequence. The FXME-RB engine processes such fax requests and updates the DB-2 records after verification. The data is then transmitted back to DB-1 and the RCEE then launches the requested command after security verification.

Thus, it can be seen that any current or suture messaging device can be used for such two-way communication for executing commands remotely. As long as the messaging device is capable of sending messages back, the response back engines can be set up to receive and process such command messages back from such devices. Since each engine works independently, as new devices come along, engines can be added easily without affecting other engines.

### SCALABILITY, EFFICIENCY, and RELIABILITY

One of the biggest advantages of this invention is how it is inherently scalable. The modular techniques of this invention allow replication of all the engines. Thus, if the work load at any given point increases, any and all the engines can be replicated and multiple copies of the engines can run simultaneously either on the same hardware or even another hardware which may be networked together. When the engines are replicated, they share the workload and thus are able to finish a given amount of work more efficiently. Additionally, if multiple copies of the engines are running, and if one of them goes down, the other engine will take up the workload—thus the system become much more reliable.

Multiple Data Transport Engines DTE-1 can be replicated and can be putting data records in the same or different databases DB-1. This is easily controlled by INI parameters that each engine uses to determine the location of the database.

Data Transport Engines DTE-2 and DTE-3 can also be replicated easily if needed. They know about each other via INI parameter called [DTE_n_Server]. Each others IP address (or any other addressing technique pertaining to the network protocol used) is specified in each INI file. So, without changing any part of the code, the system becomes very scalable by simply running multiple instances of the engines and just setting the correct INI values. This provides more efficiency and reliability also.

Finally, the same logic holds true for all the various messaging engines, which are part of this system. If at any point the voice message workload becomes high, running another instance of the VCME could be a quick solution. In some cases, of course, additional hardware, such as more phone-lines may be needed also. Similarly, the EMME, PPME, PGME, XXME, EMME-RB, PPME-RB, PGME-RB and the XXME-RB engines can also be replicated. Once replicated, they share the workload for efficiency and back each other up for reliability. Further note that the system shown in FIG. 1 depicts any enterprise and many such enterprises may be using their individual systems at the same time. Also, an enterprise may choose to use items 14 through 31 of FIG. 1 provided by some service provider that may choose to implement such systems. As such, whole or part of the systems can be replicated for even more scalability, efficiency and reliability.

### SECURITY

The system uses a reliable encryption technique to save any sensitive data such as the userid, the password and the authorization code in the databases and when transmitting these over the network. On the other end, the system decrypts these when needed.

### ACCESSING THE SYSTEM THROUGH A WEB BROWSER

As stated earlier in this document, this system works with enterprise wide applications. This means that applications that are web enabled and can be accessed through a web browser are also valid. Again, the application can either interface with the database DB-1 directly by coding their own techniques using, but not limited to ODBC, JDBC, etc. or they may choose a standard interface such as DTE-1 (5). Similarly, client/server applications written in any modern day programming language with database interface capabilities, such as but not limited to Visual Basic, Visual C++, Visual J++, etc. can be used to accomplish the same. Furthermore, automated applications that run on servers, too, can utilize this invention for all their messaging purposes.

### AUTOMATIC MESSAGE ESCALATION

The system has a built-in automatic escalation method. First of all, the system administrator sets up several records in the INI file having the following format, for example:

Escalation_Device_1=Fax

Escalation_Device_2=Email

Escalation_Device_3=Pager

Escalation_Device_4=MobilePhone

Escalation_Device_5=WorkPhone

Escalation_Device_6=PamPilot

Escalation_Device_7=HomePhone

Escalation_Device_8=Future_Device

The Data Transport Engine DTE-1 (5) uses the values specified in the database DB-1 (5) fields AutoEscalation, AutoEscalationlnterval and AutoEscalationRetries to keep re-queuing the messages until an the recipient acknowledges receipt by executing a remote command called “ACKNOWLEDGEMENT” via the RCE capability described in this document. The “ACKNOWLEDGEMENT” command is a dummy command that does nothing on the server. It is just executed by the recipient to tell the system that he/she has received the message. The recipient does not have to execute the “ACKNOWLEDGEMENT” command. He/she can execute any other valid command, too. If the recipient does not acknowledge receipt of the message, the system will retry as many times as specified in the AutoEscalationRetries field waiting AutoEscalationInterval number of seconds before attempting to send the message to the next device in the hierarchy defined via the Escalation_Device_n records in the INI file. As an example, with the Escalation_Device_n records, if the AutoEscalation=1, AutoEscalationRetries=2 and AutoEscalationlnterval=60, the system will attempt to send the message via e-mail first, then to the pager, mobile phone, work phone, palm pilot, fax, home phone, and future device, in sequence, waiting 60 seconds in between each device attempt. It will do so 2 times or if the user sends an acknowledgement—whichever comes first. If the AutoEscalation=0, no automatic escalation is done by the system. In that case, the system sends messages to devices that were specified. If AutoEscalation=2, the system regards this as an URGENT message and sends the message to all the devices simultaneously. It attempts this 2 times or if the user sends an acknowledgement—whichever comes first. Note that the messages are automatically converted to the correct format by the various messaging engines as described in this document. Also note that the system also enables the various enterprise-wide applications to code their own escalation methods since they are allowed direct access to the database DB-1 (5).

The database DB-1 (11) and DB-2 (18) contain a “Priority” field which further helps with escalation process. A higher value specified in this field means higher priority. One way to implement this is FCFS (first come first serve) and if there are several messages queued in the system by the same sender, the system sorts the messages by priority for a particular sender. Various enterprises can implement various priorities for different user groups based on their business rules and policies without adversely affecting others who may be sharing the system.

### USING THE SYSTEM WITHOUT PRE-SUBSCRIPTION/PRE-REGISTRATION

It is not necessary to pre-subscribe to be able to receive messages with this system. A message can be sent by an application or a human by simply specifying the required information of the destination messaging devices. For example, if a recipients phone number is known, a message can be sent to the recipient without forcing the recipient to first “register” onto the system. This is possible because the system checks the userid, the password and authorization code of the sender. This provides a great advantage when the recipient list changes frequently or if group messaging is being set up because it can be done quickly. Consistent with the security checks of this system, if a recipient does not pre-subscribe/pre-register and does not have a valid userid, password and authorization code, he/she will not be allowed to execute commands via the Remote Command Execution (RCE) capability. Also note that it is not necessary to subscribe to one mail box. Various messaging devices may be serviced by various service providers. In other words, it is not required, for example, that the pager and the mobile phone be serviced by the same wireless company. As long as valid information pertaining to the various messaging devices is furnished, the system is able to deliver the message. For this reason, the system works multi-nationally. However, requirement for pre-subscription and preregistration is left as a flexibility option for the various enterprises to decide. If they want to implement this requirement for business reasons, etc., this system will function as well, too.

### EXAMPLES OF USES

As mentioned before, the power of what is described here comes from the fact that these techniques can be used by and for virtually any enterprise (having functioning modern-day messaging devices) in the world. In other words, any individual or corporation/business, non-profit organization or any organization can potentially use the technologies described here in this document. Here, we describe some more in details. However, these are only some of the examples.

### Airlines

Airlines can use the engines described here to send out broadcast phone messages, pager messages, faxes, palmpilot messages, and e-mails to their passengers when an important event occurs. For example, if a flight gets delayed or cancelled, the airlines can use the engines to send messages to all passengers on the particular flight. The beauty of this system is that it is not just limited to e-mail or just to pagers. What if the person is already traveling and is on the road? How is he/she going to read the e-mail? That is why the system described here is much better because it can send messages to all electronic messaging media including the mobile phones. The airlines already should have some of this information pertaining to their passengers (their phone numbers, e-mails, etc.) from the time they booked their flights. In the foregoing example, if the passenger is already on the road going towards the airport, sending an automated message to the mobile phone makes a lot more sense than sending him/her a fax. Since the system described here is capable of sending messages to all messaging media, the chances of getting the message to the passenger is much higher. Thus, this system is much better and provides a great value added service and results in increased profitability. This is a good example of “group-messaging” and not requiring the recipients to pre-register to this system first in order to receive messages.

### Drug Stores

Drug stores are currently very busy and are facing tough competition. It will give them a big advantage to add some value-added service such as the one being described below.

When a patient takes their prescriptions to the drug stores, they have to wait or have to come back later. Frequently, the prescriptions may still not be filled. Since the drug stores already have the patients phone numbers in their database, the voice engine described here can call the patient on their phones as soon as the prescription gets filled. The modern day pharmacies already use computers to keep track while the prescriptions are being filled. Once the prescription is filled (when the pharmacist clicks the “Filled” button in their application, for example), the system can be interfaced with the voice engine and a voice message can be sent out to the patient telling him/her that the prescription is filled and ready for pick up. Some pharmacies have tried to send this type of message via e-mails. The big flaw with that logic is that many customers still do not have e-mails. Further, many customers will not go running back to sit in front of their computers waiting for an e-mail to arrive from the pharmacy. It makes a whole lot of sense to send a message to the customers' telephones and to other messaging media that they may wish.

The pharmacies can use this system for automatic reminders also. If a prescription is coming up for a re-fill, they can automatically call the patient and remind them and prompt them to place the re-fill order promptly. They could also offer special deals and discounts and short advertisements. There are many other similar uses.

### Hospitals

Hospitals can use the engines for automatic reminders to staff and doctors reminding them of important meetings and their day's schedules. Patients can also benefit ftom this system. The patients can receive automatic phone reminders in their rooms when it is time for them to take medicines. This would be especially useful for patients suffering from Alzheimer disease.

### Doctors' Offices

Doctors can use this system to automatically remind their patients of their appointments—which may result in a higher turn out and contribute positively towards their income. They could also use this system to prompt patients to pay their late bills.

### Busy Folks

Another great use of this technology is for busy people like business people, people travelling a lot, lawyers, doctors, etc. can queue up reminders to be sent to all the various messaging devices that they may own. Also, someone may be attempting to contact them with a really important message. Based on their day's schedule and the nature of their business, they may not have access to certain messaging devices during various times of the day. AS such, a system such as this one with automatic escalation capability or simultaneous broadcast to all messaging devices may prove very beneficial in contacting the recipient.

### Server Monitoring

Large (or small) corporations that have servers and other equipment to monitor can use this system. They just have to interface their monitoring systems with the engines using Data Transport Engine DTE-1 (5) or database techniques described here. If a server or any other machine is malfunctioning, their monitoring software just has to put an entry in the engines' database and the message will be sent out. The systems administrator can then use the Remote Command Execution (RCE) capability of this system to call back and execute commands using a telephone keypad, voice commands, e-mail or fax, for example. This gives them a powerful tool to take corrective actions and attempt to bring the system back to normal condition. This could be a very useful tool in providing reliable service and minimize downtime.

### Utility Companies

Many states in USA have a “dig test” law. Under this law, a person or a construction company must call a phone number (usually answered by an authorized agency) and request a clearance from the utility company before the person can start digging. This is done to avoid accidents by avoiding digging through electric underground wires or gas pipes. Once the request is made, the utility companies have several hours (48 hours in Texas, for example) to call the requester back to grant a permission or deny the request and send a technician on site. Currently, the utility companies spend hundreds and thousands of dollars making phone calls to the requestors informing then of granted permission to dig. These companies can save significant amount of money by automating the process as described here. (See FIG. 10).

What is claimed is:

1. A network messaging system that is capable of receiving messages from worldwide enterprises' applications and individuals in various formats including, but not limited to, voice, text, graphics, video, and sound, and capable of automatically converting and delivering them to multiple messaging devices in singular or broadcast manner and providing the additional capability of a 2-way communication where the recipients can respond back by using various messaging devices. The system uses databases for storing the messages, status, destination device information, etc. These messages may be delivered directly into the database by authorized applications in the enterprise or by using a standard interface—giving significant flexibility for expeditious system development and deployment. Additionally, the systems modular methods (called “engines” in this invention) allow for easy replication resulting in scalability, higher efficiency and reliability.

2. The messaging system set forth in claim 1 comprising methods of providing a two-way communication by the recipients to acknowledge receipt of the messages and/or to execute commands remotely.

3. The messaging system set forth in claim 1 comprising capability of providing automatic escalation of delivery of messages.

4. The messaging system set forth in claim 1 comprising methods of scalability, efficiency and reliability.

5. The messaging system set forth in claim 1 comprises capabilities for automatic directory lookups for broadcast (group) messaging.

6. The messaging system set forth in claim 1 comprises methods for alternate messaging protocols.

7. The messaging system set forth in claim 1 has multiple industry uses as described in some examples given in “Examples Of Uses” section of this document.

8. The messaging system set forth in claim 1 can be implemented for automated messaging from various enterprise-wide applications including but not limited to server applications, client/server applications, web browser based applications and direct interface from messaging devices.

9. The messaging system set forth in claim 1 handles any and all messaging devices such as, but not limited to wireless telephones, wired telephones, pagers, palmpilots, fax machines, e-mails, etc. It does not necessarily require pre-registration or subscription to a particular service provider—which results in flexibility and expeditious implementation of the system.

10. The methods of claim 2 of providing a two-way communication include methods for the recipient to acknowledge receipt of the message and/or respond back by using any of the messaging devices.

11. The methods of claim 2 of providing a two-way communication include methods for the system to accepts and process the responses and verify authorization before accepting the responses.

12. The methods of claim 2 of providing a two-way communication include methods of delivering the responses back to the appropriate destinations.

13. The methods of claim 2 of providing a two-way communication include a capability to receive, to verify authorization and accept commands from authorized recipients.

14. The methods of claim 2 of providing a two-way communication include a capability of execution of commands (claim 8) on the specified host.

15. The methods set forth in claim 3 for providing automatic escalation of delivery of messages include capability of the system to accept a hierarchy of messaging devices to be used for automatic message delivery escalation.

16. The methods set forth in claim 3 for providing automatic escalation of delivery of messages include capability of the system to accept specification of escalation time intervals which is used by the system to attempt delivering the message to the next device in the hierarchy after a delay of the specified interval if the recipient does not acknowledge receipt.

17. The methods set forth in claim 3 for providing automatic escalation of delivery of messages include capability of the system to broadcast messages to all the devices in the hierarchy if the message is designated as urgent.

18. The methods set forth in claim 4 for providing scalability, efficiency and reliability comprise modular techniques of creating the various methods called the engines.

19. The methods set forth in claim 4 for providing scalability, efficiency and reliability allow for replication of these engines on a given system.

20. The methods set forth in claim 4 for providing scalability, efficiency and reliability have the capability of replicating the whole system for further scalability, efficiency and reliability.
